(19) United States
(12) Patent Application Publication
(10) Pub. No.: US 2011/0299095 A1
(43) Pub. Date: Dec. 8, 2011

(54) Shadow Sensing Apparatus

(75) Inventors: Colin George Morgan, Oxford (GB); Andrew Howard Spalding, London (GB)

(73) Assignee: ADAPTIVE AUTOMATION LIMITED, Kempston, Bedford (GB)

(21) Appl. No.: 13/128,273

(22) PCT Filed: Nov. 5, 2009
(86) PCT No.: PCT/GB09/02614

§ 371 Date: Aug. 26, 2011

(30) Foreign Application Priority Data
Nov. 8, 2008 (GB) 0820458.8

(51) Int. Cl. G01B 11/14

(52) U.S. Cl. 356/614

(57) ABSTRACT

Shadow sensing apparatus for measuring the cross-section and/or position of a tool such as a welding tool at its intersection with a sensor plane, the apparatus having three sensor channels, each comprising a linear array of discrete light sources and a linear light sensor opposite the light sources to receive light emitted therefrom. Each of the channels intersects each other to define a common sensor plane. The light sources are actuatable individually to direct light towards the tool and the respective sensor is arranged to sense the shadow cast thereon by the tool. The cross-section and/or position of the tool or other subject can be determined from up to n×C shadow images, where n is the number of light sources in each of the arrays and C is the number of channels.

### TECHNICAL FIELD

This invention relates to shadow sensing apparatus for use in measuring the cross-section and/or position of a tool or other subject at its intersection with a sensor plane. A particular application of the apparatus is in sensing the position and/or cross-section of a robotically controlled tool, such as a welding tool.

### BACKGROUND ART

Shadowing is a well established optical measuring technique and forms the basis of a wide range of instruments. For example, in an optical micrometer, a parallel sheet of light, (either static of scanning) is cut by the object to be measured. From the extent of the shadow cast on a detector, an accurate estimate of the position and size of the object can be calculated. The optical micrometer is essentially a one-dimensional (1-D) measuring device.

The invention seeks to provide an improved shadow sensing apparatus. Preferred embodiments allow 2-D measurements which are capable of determining both the position and cross-sectional form of a wide range of simple convex objects.

### SUMMARY OF INVENTION

According to a first aspect of the invention, there is provided a shadow sensing apparatus for use in measuring the cross-section and/or position of a tool or other subject at its intersection with a sensor plane, the apparatus comprising three or more sensor channels, each of which comprises a linear array of light sources with a linear light sensor positioned opposite the light sources so as to receive light emitted therefrom, each of the channels intersecting each of the other channels and arranged so that the light paths between each array of light sources and the respective linear light sensor define a common sensor plane, the light sources in each array being actuatable individually to direct light towards a tool or other subject positioned to intersect said sensor plane and the respective linear sensor being arranged to sense the shadow cast thereon by the tool or other subject, whereby the sensors collectively detect up to n×C shadow images, where n is the number of light sources in each of the arrays and C is the number of channels, from which information regarding the cross-section and/or position of the tool or other subject can be determined.

Preferred and optional features of the invention will be apparent from the following description and from the subsidiary claims of the specification.

### BRIEF DESCRIPTION OF DRAWINGS

The invention will now be further described, merely by way of example, with reference to the accompanying drawings, in which:

FIG. 1 is a schematic plan view of a preferred embodiment of a shadow sensing apparatus illustrating the limits of some of the light paths therein;

FIG. 2 is a similar schematic plan view illustrating light paths in relation to a subject with a circular cross-section;

FIG. 3A is a similar schematic plan view illustrating further light paths in relation to a subject with a circular cross-section and FIG. 3B is an enlarged view of the subject and the light paths shown;

FIG. 4A is a similar schematic plan view illustrating light paths in relation to a subject with a semi-circular cross-section and FIG. 4B is an enlarged view of the subject and the light paths shown;

FIGS. 5A and 5B are graphs illustrating light signals generated by a light sensor of the preferred embodiment; and

FIG. 6A is a plan view of a preferred embodiment of apparatus according to the present invention and FIG. 6B is a cross-sectional, view thereof taken along line A-A′shown in FIG. 6A.

### DESCRIPTION OF PREFERRED EMBODIMENTS

The Figures illustrate apparatus which comprises three sensor channels in a hexagonal arrangement. This is the preferred number of channels. A greater number of channels can be used but the larger the number of channels, the more complex the apparatus will be and the more problems tend to arise with cross-talk between the channels. An odd number of channels is also preferred to improve the symmetry (using an even number of channels gives rise to asymmetric light paths) as the arrays of light sources and the linear light sensors will then alternate around the apparatus (as in the embodiment illustrated).

FIG. 1 is a schematic plan view of a preferred arrangement. A first linear array 1 of light sources is positioned opposite a first linear sensor 2 to form a first sensor channel C1. A second linear array 3 of light sources is positioned opposite a second linear sensor 4 to form a second sensor channel C2. And, a third linear array 5 of light sources is positioned opposite a third linear sensor 6 to form a third sensor channel C3.

As shown, the three channels C1, C2 and C3 intersect each other and are arranged at 120 degrees to each other so that the arrays 1, 3, 5 of light sources and the linear sensors 2, 4, 6 are in a hexagonal arrangement.

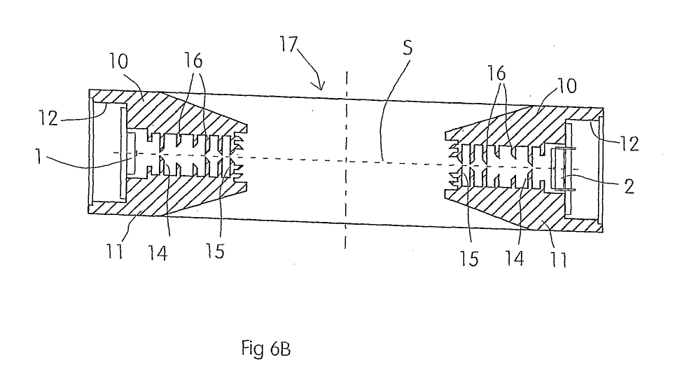

Each array of light sources comprises a plurality of discrete radiating light sources, e.g. light emitting diodes (LEDs), spaced apart along the length of the array. In the arrangement shown, each array comprises five LEDs, L1, L2, L3, L4 and L5. Each of the light sensors emits a diverging beam of light. This beam of light is constrained to a single, narrow plane (e.g. by a slit in front of the light source and/or by baffles, which is described further below with reference to FIG. 6). All the light sources of each array emit such divergent beams in the same common plane which thus forms the sensor plane S of the apparatus (see FIG. 6). Typically, the sensor plane has a thickness (perpendicular to the plane) of less than 1 mm.

The linear detectors 2, 4, 6 each typically comprises a CCD array, for example an array of a thousand or more contiguous devices, each device typically being several microns wide (along the length of the array) and forming a pixel of the sensor array. An example would be an array of 2048 sensors (or pixels) each 14 microns square.

FIG. 1 shows light paths P1, P2 from light sources L1, L5 respectively for each of the channels C1, C2, C3, these being the limit rays which fall upon the respective detector 2, 4, 6.

FIG. 1 also shows potential interference light path P3, P4, P5, P6 between light sources L1 and L5 and the adjacent linear sensors. To prevent (or at least minimise) such light paths causing cross-talk between the sensor channels, the apparatus is provided with baffles 7 between each of the arrays of light sources and the adjacent linear detection.

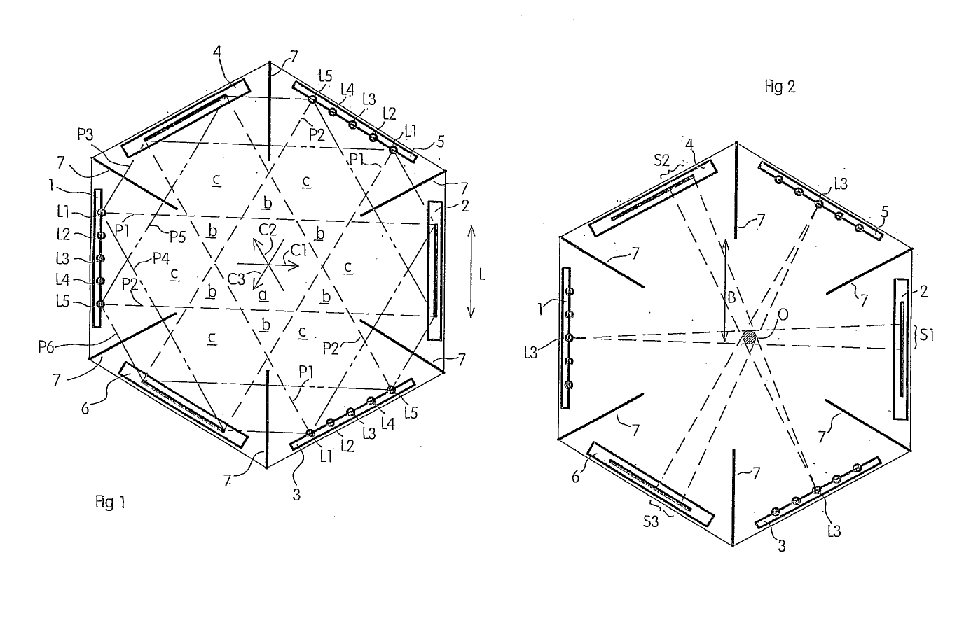

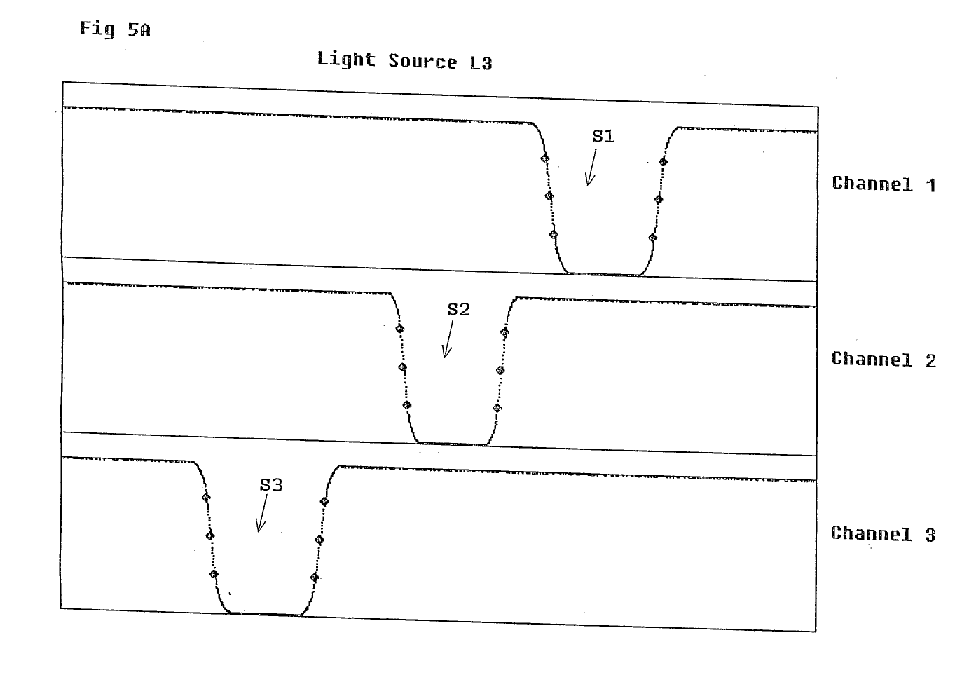

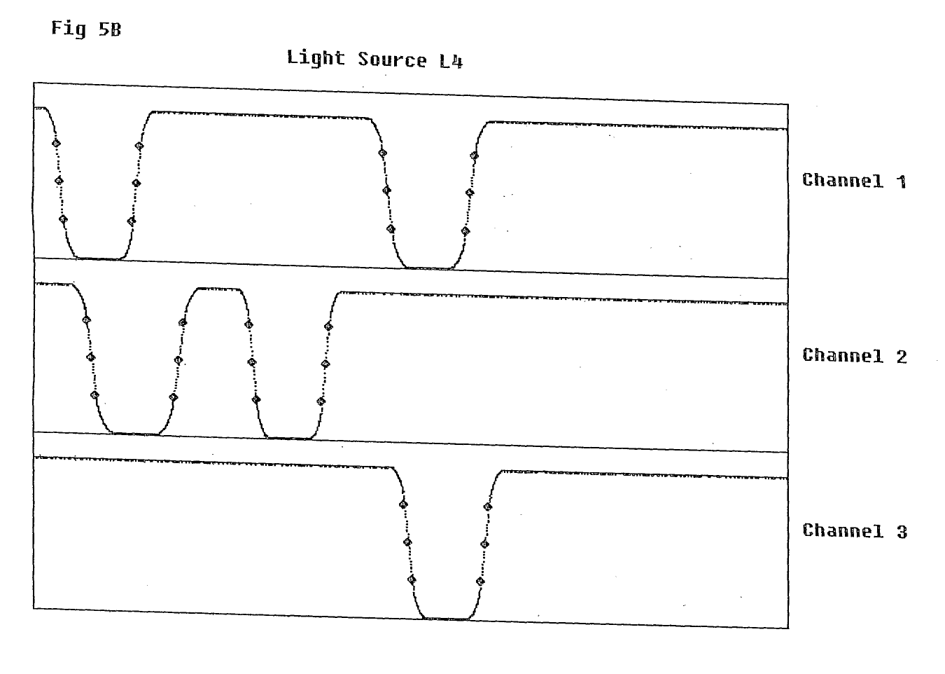

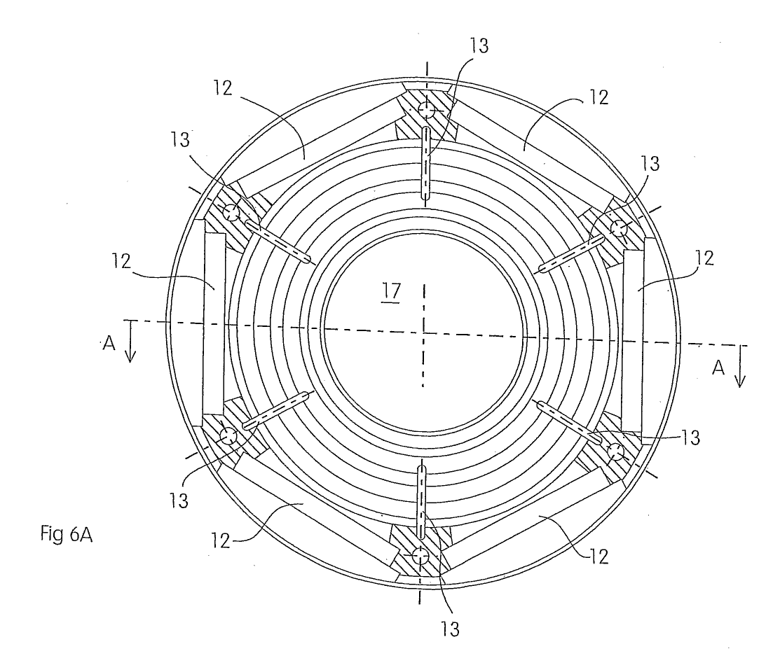

FIG. 2 illustrates how LEDs L3 of each of the array of light sources 1, 3, 5 cast shadows S on the respective linear detector arrays 2, 4, 6, the Figure showing the light paths which are tangential to the object (in this case an object O positioned just off centre in the sensor plane and having a circular cross-section). The linear detector arrays will generate signals indicating the edges of the shadows S (as described further below with reference to FIG. 5).

Various measurement zones in the sensor plane are shown in FIG. 1:—
a) a central hexagonal zone. When the object intersects this zone, all three sensor channels contribute to the signal produced.
b) the six triangular zones adjacent the sides of the central hexagonal zone: in these zones, two of the sensor channels will contribute to the signal produced.
c) in the outer zones surrounding the above, some data is obtained from one or more LED images in just one sensor channel.

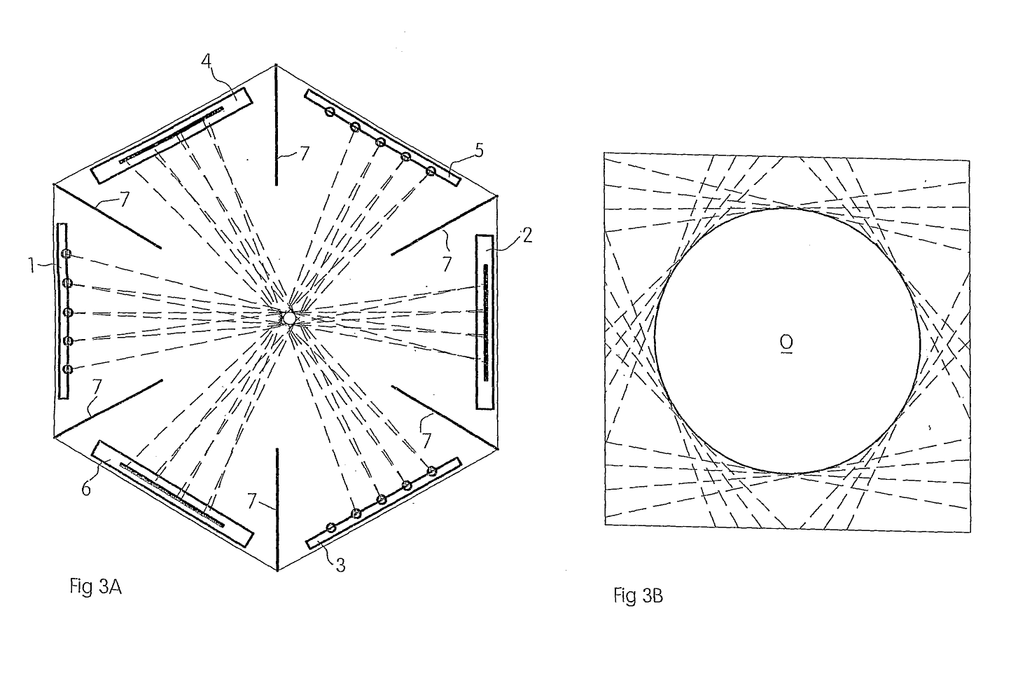

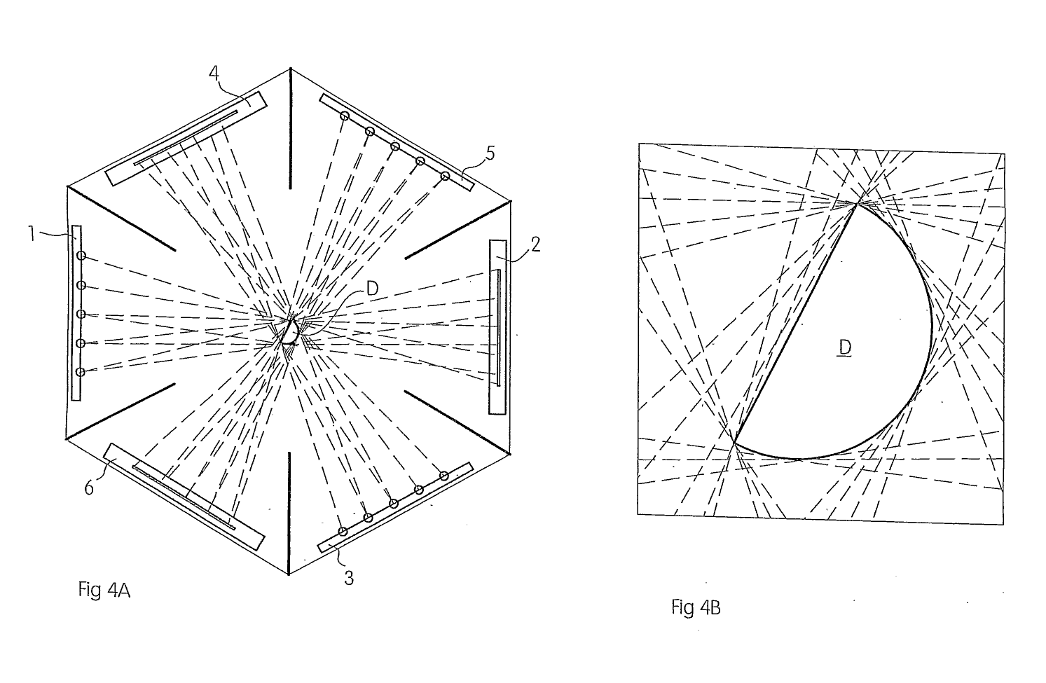

The edges of the shadows formed by each of the LEDs form a set of tangential ray paths around the perimeter of the target object as illustrated in FIGS. 2 and 3. It should be noted that FIG. 3 only shows light paths which form the edge of shadows which fall on one of the linear detector arrays.

The closer the target is to the centre of the sensor plane, the more potential tangential measurements of that target can be obtained. With the arrangement shown in the drawings, a small central target will produce up to 30 measurements around its circumference. Moving away from the centre of the measurement zone, fewer of the shadow edges will fall within the detection range. It should be noted that both edges of a particular shadow do not need to be seen by the detector in order to make use of that measurement.

The number of these ray paths required to provide a useful measurement will depend upon the application:—

If the sensor is used as a wire finder for a welding torch, a welding wire of known diameter is expected. Accordingly, as few as two rays are sufficient to define the target's position. With additional measurements, a better average position can be found and/or the individual rays checked for self-consistency. With twin-core welding torches, the software needs to recognise two separate circular cross-section targets.

More complex shapes will in general require more tangent rays in order to be identified and measured: a wire or cylindrical target inserted into the measuring aperture inclined at an angle to the sensors axis would show an elliptical cross-section. From the aspect ratio and orientation of this ellipse, the inclination angles can be estimated.

With a micrometer one would typically make a measure across flat faces whereas with this device a 2-D outline of the perimeter of the cross-section where this intersects the sensor plane is determined. For a smooth convex target, the tangent rays will be distributed reasonably uniformly around its perimeter allowing a fitted profile to be constructed as well as its actual position. This is illustrated in FIGS. 3A and 3B for an object O with a circular cross-section.

Where the target has straight edges (eg as a rectangular, triangular of polygonal cross-section), the tangent rays will concentrate at the vertices, the positions of which can then be measured and compared if required to a model part. This is illustrated in FIGS. 4A and 4B for an object D with a semi-circular cross-section.

Where the vertices correspond to the cutting edges of a tool, an estimate of the quality of that edge is possible dependent upon the accuracy of the sensors own calibration procedure. This is possible by examining the spread in values of the ray intercepts: a sharp tool will show a small spread of values whereas a blunt tool will show a larger spread.

It should be noted that these measurement techniques only measure “convex” forms, ie no information from any concave or hollow parts of the target will be determined.

Images from the three detectors are captured and processed to determine the shadow positions and the edge slope. FIG. 5A shows a simulation of the signals sensed by the linear detectors of the three channels when one of the corresponding sets of light source is actuated, in this case L3, for a single circular object as illustrated in FIG. 2. The x-axis represents the position along the linear detector where the signal is detected and the y-axis represents the signal strength (zero in full shadow and 100% in full illumination). The analysis has identified and marked the positions on each shadow identified as corresponding to 25%, 50% and 75% signal strengths. A complete set of observations would consist of five such sets of images corresponding to each of the five light sources L1 to L5.

FIG. 5B shows an example of a somewhat more complex simulation, eg where the target is that of a twin core MIG welding torch. In this example, the images show up to two shadows in each channel.

FIGS. 6A and 6B illustrate a preferred embodiment of the apparatus described above.

The mechanical design of the sensing apparatus has to satisfy a number of optical considerations. Clean light paths are required between the LEDs and their corresponding CCD detectors while minimising interference or cross-talk from the other two channels. At the same time, interference from any external light source must also be minimised. FIG. 6 shows apparatus manufactured from a matched pair of turned metal plates 10, 11 with milled recesses 12 for receiving the CCD detectors 2, 4, 6 and LED PCBs 1, 3, 5 around the perimeter thereof and with milled grooves 13 for receiving the separation baffles 7. Inner and outer knife edges 14, 15 limit the required light path to that of a narrow, sub-millimetre plane. Additional turned baffles 16 are designed to prevent all but the required light source from reaching the detectors without first undergoing multiple reflections on-route.

The turned plates are secured together with a gap of about 0.8 mm therebetween as shown in FIG. 6B.

The inner surface of the sensing apparatus preferably has a matt-black finish to absorb as much of this undesirable light as possible. Objects to be measured would in general be inserted into the measurement aperture 17 perpendicular to the sensor plane S.

This optics chamber formed by the turned plates 10, 11 may be joined to a handle (not shown) which houses micro-processor based electronics for the control of the sensor, for processing images and for communicating with the outside world (eg a robot, programmable logic controller (PLC) or other computer). The sensing apparatus would typically be mounted horizontally and rigidly within a work envelope of a robot such that tools to be measured, for example a welding torch wire tip, can be readily presented to the sensing apparatus.

In the case of a spot welding gun, access would be from either side of the apparatus. Although the tool is preferably presented with its axis perpendicular to the sensor plane S, it is not necessary for the robot to approach the sensing apparatus with its other axes aligned to those of the apparatus. During a teaching or calibration phase, the sensor's firmware can determine for itself the orientation of the tool and convert its offset measurements into the coordinate frame required by the robot.

Thus, the sensing apparatus described comprises a geometric arrangement (in this case a hexagon), with the sides alternating between a linear detector and a linear array “point light sources”. All components are co-planar forming a narrow, sub-millimetre sensor plane. The three opposing pairs of detectors and light sources form three measurement channels. The alternate arrangement enables each channel to be separated from its neighbours by a baffle which prevents mutual interference or cross-talk. The central area forms the sensor measurement zone. Objects placed within this zone obstruct the light paths between the point light sources and the linear detector, casting a shadow onto the latter.

In operation, only one light source in turn from each of the three channels is switched on casting its shadow on the corresponding linear detector. Measurements are preferably taken simultaneously in each of the three channels, eg as illustrated in FIG. 2. A series of images from each of the three detectors arrays are thus captured as the LEDs 1 to 5 of each light source are sequentially actuated and the signals sensed are processed to determine the shadow position and edge slope. The geometry is arranged such that the three channels do not interfere with each other so that the corresponding light sources on all three channels can capture images simultaneously. This is repeated for each of the light sources in turn resulting in a total of (number of channels C)×(number of light sources n) of images. In the example illustrated this gives a maximum of 3×5=15 images (and hence 30 shadow edges).

Using projections from the individual light sources to the corresponding shadow positions on the detectors, the size and location of the target object(s) can be computed. The geometry of the sensing apparatus is such that a good all round view of the target can be determined.

The scale of the device is determined by the choice of detector used. Typically, the detector is a linear CCD. This may, for example, comprise 2048 pixels each 14 microns square. This gives a total light sensing length of a little over 28 mm. The light sources should be as close to “point like” as is practical. One suitable choice is surface mounted light emitting diodes (LEDs) which are available with an effective emitting area significantly less than 0.1 mm square. This is important because the size of the light source will determine the smallest target object capable of casting a shadow on the detector and hence the smallest object that can be measured. For example, the light sources may comprise 5 LEDs separated by 7 mm from each other, giving a total spread of source positions of 28 mm (which matches the length of the detector). Preferably, the light source output is spread out over a broad viewing angle so as to illuminate the full extent of the detector and beyond (rather than just a narrow laser like beam). Other similar light detectors can be used in place of the CCD detectors, e.g. CMOS, CID, NMOS, etc.

Other dimensions follow from this basic choice of detector and LED spacing. The baffles blocking cross-talk or interference between LEDs and their neighbouring CCD must extend far enough towards the centre of the sensor zone to cut off the interfering limit rays but not so far as to obstruct the limit rays of the LEDs with its own CCD.

If the basic CCD length=LED spread=(28 mm)=L (see FIG. 1)
then the minimum baffle separation B (see FIG. 2) from the centre is also=L
In practice we need:—

B>L (1)

If the overall separation of CCD and LEDs, i.e. the width of the hexagon=D, then we require the minimum size for D.

D>5L/sqrt(3)=80.8mm (2)

To satisfy both of equations (1) and (2), D should preferably be greater than this minimum in order to give a good clearance for the blocking baffles 7. In the example given, D=100 mm. This allows B to be slightly greater than L to clear the limit rays. D should not be too big as this will make the device bulkier and also limit the angular coverage of the measurements.

In another embodiment (not shown), the optics chamber may be formed in two parts which are hinged together so as to allow it to be opened and positioned around an object (eg an extruded part) and then closed and the two parts locked together accurately before use.

Air ducts may be provided whereby compressed air can be applied to maintain the optics chamber at a positive pressure and/or to flush out the optics chamber.

Optical windows may also be provided to help keep dirt out from the sensor optical path and seal it against contamination from water, oil etc. The window(s) would be placed close to the inner diameter of the optics chamber and may be in the form of a thin clear plastic or glass cylinder. Alternatively, six individual flat glass windows may be used. These windows would be located across the ends of the spacer baffles so as not to interfere with the optical path. Ideally, the windows would be angled and/or optically coated to minimise reflections. Another option is to use compressed air to maintain a small, positive pressure in the optical chamber (either continuously or intermittently) to flush dirt out of the apparatus and to inhibit its ingress.

In order to use this sensor to make accurate measurements, particularly for applications such as checking tool sharpness, the instrument should be accurately calibrated. This requires the exact sensor geometry to be determined, ie the precise coordinates of the LEDs and detectors. In addition, the dimensions and light distribution patterns of the LEDs are required in order to interpret the shadow edge positions. Such a calibration procedure can be performed with the aid of a computer controlled XY-table in which a small pin target is programmed to move about the measurement zone visiting an hexagonal array of positions at which image data is captured and processed. Fitting algorithms can then be used to process this data and construct projections back to the individual LEDs and CCD. The slopes of the shadow sides depend upon the finite size of the LED light sources and also upon the image magnification, the ratio of the separation of the CCD and LED divided by the LED to target distance. From this data, a model of the LED output can be constructed.

The sensor described above has the advantage that the three measurement channels do not interfere with each other so the images can be captured simultaneously in each of the sensor channels. The requirement to be able to operate the channels simultaneously imposes a minimum separation between light sources and detector and the inclusion of baffles to prevent cross-talk or interference (as described above). In a further arrangement (not shown), the baffles may be omitted to reduce the size of the hexagon (so that the sides are only a little larger than the length of the linear detector array). This provides a smaller instrument and a better all round angular coverage of the target but cross-talk between the sensor channels prevents simultaneous exposure so it would be slower in operation by a factor of three. However, it would also be possible to use light sources of different wavelength in each of the channels with corresponding optical filters in front of the linear detectors to avoid this problem.

As described above, the instrument can use readily available light sources such as surface mounted miniature LEDs. These are typically LED dice or small surface mounted devices (rather than a plastic encapsulated type). The optimal device would be a near “point source” of divergent light and LEDs are available with an emitting area less than 0.1 mm across. These LEDs are typically wide angle, emitting light more or less uniformly in all directions, eg with a 160 degree viewing angle. In practice, only a small fraction of the light will fall in the plane of the detector but lack of signal is unlikely to be an issue. LEDs emit light over a range of wavelengths.

Another possibility would be to use laser diodes. Unlike LEDs, these devices are near monochromatic and can be obtained in different wavelengths from infrared to the near UV. They tend to emit light in a cone with an elliptical cross-section, typically three times as wide in one plane than the other so laser diodes only form the characteristic narrow “laser” beam of light if combined with suitable collimating optics. Laser diodes may be a better match to the needs of the detector than an LED and with a far better light budget. However, they are more expensive. Another disadvantage may be signal strength; the laser might overwhelm the needs of the detectors. However, this would not matter with a “high speed” detector using super fast linear CCD detectors. In this case, the laser diode may be the preferred light source.

Other light sources may also be used, eg customised hybrid design LED dice modules, or customised fibre-optic coupled light sources, etc.

These LEDs typically have a broad 2-D angular power output which means that only a small, fraction of the output is used. While lack of signal is unlikely to be a serious issue, the sensor could also employ a source which is very narrow in one plane and just wide enough in the other to illuminate the respective detector uniformly. In addition, optical components may be used to improve the light budget, eg a miniature cylindrical optical lens (not shown) may be positioned just in front of the LEDs. A similar cylindrical lens mounted just in front of the CCD linear pixel array would also allow the capture of a greater fraction of the available signal.

The read-out speed of a linear CCD is typically about one millisecond, although devices are available that are over an order of magnitude faster than this. A complete set of measurements can thus typically be captured within a few milliseconds.

A variety of different algorithms may be used to process the data from the linear sensors to calibrate the instrument, to locate and to measure possible shapes (circles, ellipses, corners, cutting edges, twin wires, extrusion profiles, TCP, etc) and to communicate with other devices such as a robot/PC/PLC (??).

Algorithms may be used to model the size of the LED and its intensity profile, to bisect shadow angles, to compute the intercept(s), and to provide best estimates.

Tangent rays can be used to determine the diameter of a circular cross-section and, if this is of a known size, a regression method can be used to provide the best fit.

The apparatus is preferably provided with an on-board micro-processor to analyse data, and to communicate with a PC, robot or PLC (via ethernet or other communications channels).

The range of possible applications for a sensing apparatus such as that described above includes the following:—
Robotic MIG or TIG welding as a “wire-finder”. Robotic welding torches are subject to wear and tear, thermal distortion and knocks. These errors result in a displacement of the weld-seam position. Without correction, poor quality and potentially dangerous product can result. The sensor can quickly measure such errors and thus allow the robot program to make the necessary corrections automatically. The nature of this sensor allows corrections to be made even where twin-core welding torched are being used.
Robotic Spot-Welding. The form of this sensor, being a slim disc, allows for entry of the target into the measurement aperture from either side. This means that both of the welding tips can be measured so that the tip alignment can also be determined. The cross-sectional form of the tips can also be checked for signs of wear thus allowing maintenance work to be optimised to match the true state of the equipment.
Robotic tool centre point (TCP) aid. The robot TCP defines the position and orientation of the robot tool relative to its mounting plate. Knowing the TCP of the robots tool allows for it to be manipulated relative to its own local coordinate system. Knowing the TCP is essential in practice for most robotic programming tasks. This sensor can be used in conjunction with a simple robot program to determine the TCP automatically.
Extrusion profile monitoring. This sensor can be used to automatically monitor the manufacture of a wide range of extruded forms. As mentioned above, a hinged opening mechanism would allow the sensor access to a running line.
Checking cutting tools for damage. A number of measurements to assess the quality of the tool are possible by inserting the tool into the sensor's measuring aperture:—
   Is the tool bent? Check for wobble as the tool is slowly rotated about its axis.
   Is the tool sharp? Measure the radius of curvature of the vertices. A sharp tool would have a minute radii, a blunt or chipped cutting edge would not.
   Is the tool broken? Check the tool profile as the tool is lowered into the measurement plane. Check that the expected profile appears at the correct point.

The apparatus described above provides a compact, relatively simple and inexpensive device for measuring the cross-section and/or position of a tool or other object. It provides good all round 2D measurement coverage of the object and can measure both 2D position and shape. A large degree of redundancy may be provided in the measurements. Multiple targets, e.g. twin-core welding wires, can also be measured simultaneously.

1. Shadow sensing apparatus for use in measuring the cross-section and/or position of a tool or other subject at its intersection with a sensor plane, the apparatus comprising three or more sensor channels, each of which comprises a linear array of discrete light sources each of which provides a substantially point source of divergent light and a linear light sensor positioned opposite the light sources so as to receive light emitted therefrom, each of the channels intersecting each of the other channels and arranged so that the divergent light paths between each array of discrete light sources and the respective linear light sensor define a common sensor plane, the discrete light sources in each array being actuatable individually to direct a divergent beam of light towards a tool or other subject positioned to intersect said sensor plane and the respective linear sensor being arranged to sense the shadow cast thereon by the tool or other subject, whereby the sensors collectively detect up to n×C shadow images, where n is the number of discrete light sources in each of the arrays and C is the number of channels, from which information regarding the cross-section and/or position of the tool or other subject can be determined.

2. Apparatus as claimed in claim 1 comprising an odd number of channels arranged so that the arrays of discrete light sources and the linear detectors alternate around the edge of the sensor plane.

3. Apparatus as claimed in claim 1 comprising three channels arranged at 120 degrees to each other.

4. Apparatus as claimed in claim 2 comprising three arrays of discrete light sources and three linear light sensors arranged alternately around the sides of a hexagon.

5. Apparatus as claimed in claim 1 in which the discrete light sources comprise divergent near point-like light sources.

6. Apparatus as claimed in claim 5 in which the discrete light sources comprise light emitting diodes (LEDs) or laser diodes.

7. Apparatus as claimed in claim 1 in which the light sensors comprise an array of devices selected from: charged couple devices (CCDs), CMOS, CID or NMOS.

8. Apparatus as claimed in claim 1 having light baffles to reduce cross-talk or interference between the sensor channels.

9. Apparatus as claimed in claim 8 in which each of the sensor channels is arranged to be actuated simultaneously.

10. Apparatus as claimed in claim 1 comprising two annular components mounted together with a gap therebetween in which the sensor plane lies.

11. Apparatus as claimed in claim 10 in which an object to be sensed can be introduced into the sensor plane by passing the object through the aperture in one or both of the annular components.

12. Apparatus as claimed in claim 10 in which the annular components comprise turned metal plates.

13. Apparatus as claimed in claim 10 in which the arrays of discrete light sources and linear sensor arrays are mounted to externally facing surfaces of the annular components bridging the gap therebetween so the discrete light sources and sensors lie in the sensor plane.

14. Apparatus as claimed in claim 1 in which air ducts are provided whereby compressed air can be applied to maintain the interior of the apparatus at a positive pressure and/or to flush out the apparatus.
